(19) United States
(12) Patent Application Publication
(10) Pub. No.: US 2005/0139579 A1
(43) Pub. Date: Jun. 30, 2005

(54) Vacuum switchgear system

(76) Inventors: Yoshiki Sakamoto, Atsugi (JP); Kenji Tsuchiya, Hitachi (JP); Masato Kobayashi, Hitachi (JP); Shuuichi Kikukawa, Hitachi (JP); Kozo Kato, Hitachi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/020,033

(22) Filed: Dec. 23, 2004

(30) Foreign Application Priority Data
Dec. 26, 2003 (JP) 2003-433376

(51) Int. Cl. H01H 33/66

(52) U.S. Cl. 218/118

(57) ABSTRACT

A vacuum switchgear system for a three phase electric power system, wherein a switchgear comprises a vacuum switch comprising a vacuum container and switches accommodated in the vacuum switch and an operation unit. Each of the switches and each of the operation units is coaxially connected with an operating rod of each of the switches. A link mechanism of the operation unit is connected with a link of the adjoining operation units of the switchgears. Each of the link mechanisms transmits a force of the driving rod assisted by an electro-magnet to the adjoining driving rods through the link mechanisms so that the operation units and the switches in the same phase and the same vacuum container are operated in synchronism in response to a switch-on signal or a switch-off signal.

### CLAIM OF PRIORITY

The present application claims priority from Japanese patent application serial No. 2003-433376, filed on Dec. 26, 2003, the content of which is hereby incorporated by reference into this application.

### FIELD OF THE INVENTION

The present invention relates to a vacuum switchgear system, and more particularly to a vacuum switchgear system comprising a plurality of switches accommodated in vacuum containers and an operation unit for operating each of the switchgears, which are suitable for receiving-distributing electric power of an electric power transmission system.

There are disposed switchgears as one element for receiving-distribution facilities of an electric power transmission system. Heretofore, air insulated switchgears have been widely used; however, gas insulated switchgears using SF₆ gas as an insulating gas are used for aiming at small sized facilities. Since the gas insulated switchgears may give adverse affects on environment, vacuum insulated switchgears using vacuum as an insulating medium are proposed in recent years.

As switchgears of the vacuum insulation system, there has been proposed a vacuum switchgear comprising a plurality of switches for a main circuit accommodated in a vacuum container, a fixed electrode and a movable electrode disposed in opposite relation with each other. The movable electrode is connected with the bus side conductor, and the fixed electrode is connected with the load side conductor. Each of the electrodes of the main switches is covered with an arc shield. Each of the bus side conductors is connected with the movable electrode by means of a flexible conductor (Patent document No.1). According to the vacuum switchgear disclosed in the patent document No. 1, which employs vacuum insulation, the insulating distance can be shorter than that of the insulating gas switchgear. Therefore, compact vacuum switchgears can be obtained.
(Patent document 1); Japanese patent laid-open 2000-26868 (pages 3 to 6, FIGS. 1-3)

### DESCRIPTION OF THE INVENTION

### SUMMARY OF THE INVENTION

The prior art does not consider the simplification of the structure of an operation unit to be connected with the switch of the switchgear and the relationship between the operation unit and the switch for downsizing the switchgear.

An object of the present invention is to downsize the switchgear system.

The present invention provides a vacuum switchgear system for a three phase system, which comprises three switchgears each comprising a vacuum switch and an operation unit, wherein each of the switches is accommodated in a vacuum container and each of the operation units is coaxially connected with an operating rod of each of the switches. The operation units of the three switchgears are connected with the adjoining operation units of the switchgears by means of link mechanisms connected with respective driving rods of the operation units. Each of the link mechanisms transmits a force of the driving rod assisted by an electro-magnet to the adjoining driving rods through the link mechanisms so that the three switchgears are operated in synchronism in response to a switch-on signal or a switch-off signal.

### BRIEF DESCRIPTION OF THE DRAWINGS

FIG. 1 is a front view of an essential part of a vacuum switchgear of one embodiment of the present invention.

FIG. 2 is a plane view of the essential part of the vacuum switchgear shown in FIG. 1.

FIG. 3 is a cross sectional view of the essential part of the vacuum switchgear shown in FIG. 1.

FIG. 4 is a front view of an essential part for explanation of relationship between the operation unit and the link mechanism of the switchgear of the present invention in an opening state.

FIG. 5 is a front view of an essential part for explanation of relationship between the operation unit and the link mechanism.

### DETAILED DESCRIPTION OF THE INVENTION

In the present specification, the vacuum switchgear system means a system for a three phase power system comprising three vacuum switchgears, wherein the switchgear comprises a vacuum switch accommodated in a vacuum container and an operation unit connected with the switchgear. The vacuum switchgear means a vacuum switch comprising a vacuum container and at least one of a main switch or a load break switch, a circuit breaker and an earth switch.

The switchgear system for a three phase electric power transmission system of the present invention is featured by:
(a) There are three switchgears each comprises a vacuum switch and an operation unit.
(b) Each of the vacuum switches comprises a vacuum container and at least a main switch and earth switch accommodated in the vacuum container.
(c) The operation unit is coaxially connected with an operating rod of each of the switches.
(d) The operation units of each of the switchgears are connected with the adjoining operation units of the switchgear in the same phase by means of a link mechanism connected with respect to driving rods of the operation units.
(e) The link mechanism transmits a force of the driving rod to the adjoining driving rods so that the switches in the same phase are operated in synchronism in response to a switch-on signal or a switch-off signal.
(f) Each of the vacuum switchgears is independently operated from other vacuum switchgears, while the switches in the vacuum container in the same phase are operated synchronously.

Technical features of the present invention may be exemplified as follows. The vacuum switchgear system of the present invention may contain one or more of the following features.
(1) A pair of an operation unit and a vacuum switch constitute a vacuum switchgear in the vacuum switchgear system of three phases. One pair of the vacuum switch and the operation unit constitutes a vacuum switchgear. The three switchgears constitute a vacuum switchgear system of the present invention.
(2) The three operation units are connected to constitute an operation unit system by means of a link mechanism. A reciprocal movement of a driving rod of an operation unit is converted swing force into a reciprocal movement.
(3) Each of the operation units and each of the switchgear are coaxially connected on the same axis. In the conventional vacuum switchgear, one large sized operation unit was employed. Such the operation unit has a large magnet and a large link mechanism to transmit a large power for operating three switchgears. The size of the switchgear system of the present invention becomes remarkably small because each of the operation units and link mechanisms can be downsized.
(4) The adjoining operation units are connected by a link mechanism comprising a pin for swing movement and a connecting rod, connected with the pin, for lateral movement or reciprocating movement.
(5) Each of the vacuum switches comprises a main switch or load break switch, an earth switch and a circuit breaker.
(6) A magneto-motive force generated by a combination of an electro-magnet and a permanent magnet is utilized. The permanent magnet is particularly useful as an initial force to start separation of the electrodes. The electro-magnet is utilized for switching on and off for the switches.
(7) The operation units are arranged zigzag in a plane of the switchgear system. Since each of the operation units has a small size, the operation units can be arranged zigzag so that the occupying area of the switchgear can be minimized.

According to the present invention, there is provided a vacuum switchgear system for a three phase electric power transmission system, which comprises three switchgears each comprising a vacuum switch and an operation unit, wherein each of the switches is accommodated in a vacuum container and each of the operation units is coaxially connected with an operating rod of each of the switches, wherein the operation units of the three switchgears are connected with the adjoining operation units of the switchgears by means of link mechanisms connected with respective driving rods of the operation units, and wherein each of the link mechanisms transmits a force of the driving rod to the adjoining driving rods through the link mechanisms so that the three switchgears are operated in synchronism in response to a switch-on signal or a switch-off signal.

In the above vacuum switchgear system, each of the link mechanism comprises a swing member one end of which is connected with one end of the driving rod of each of the operation units to convert a reciprocal movement of the driving rod into a swing movement and a connecting rod one end of which is connected with the swing member and the other end is connected with the adjoining swing member to convert the swing movement into a lateral movement.

Further, in the above vacuum switchgear system, the driving rod is assisted by an electromagnet in closing the switches and is assisted by the electromagnet and a permanent magnet in opening the switches.

Still further, in the above vacuum switchgear system, the link mechanisms are restrained in the system so as to synchronize the lateral movement of the connecting rods of the three switchgears. The base members 128, 134, 148, 158, etc support the link mechanisms in the switchgear system and restrain the link systems in the system.

In the above vacuum switchgear system, the switchgear system comprises three switchgears for three phases each comprising a vacuum switch and an operation unit, wherein each of the switches comprises at least a main switch and an earth switch, and if necessary a circuit breaker, accommodated in a vacuum container, each of the operation units being coaxially connected with an operating rod of each of the switches. The operation units of the three switchgears are connected with the adjoining operation units of the switchgear by means of a link mechanism, which has a first member connected with one end of a driving rod of each of the operation units and is disposed to swing around its connecting point as a fulcrum and a second member which is connected with one end of the first member to convert a swing movement of the first member into a lateral movement and transmit the lateral force to the adjoining link mechanisms, whereby the switches in the same phase in the same vacuum container are operated synchronously in response to a switch on signal or a switch off signal.

In the above vacuum switchgear system, each of the operation units is connected with each of the switches by means of an operating rod, wherein each of the operation units imparts the operating force by magneto-motive force to the operating rod in closing the switches. In opening of the switches an operating force by elasticity in the reverse direction with respect to the electromotive force to the operating rod, each of the operation units of each of the phases being connected with two switches having relation with the operation unit. Each of the switches and each of the operation units having relation with the switch are arranged in the closest relation on a same axis with respect to the operating rod. Each of the operation units is disposed above each of the switches having relation with the operation unit on an axis of the operating rod. Each of the switches comprises three load break switches, a circuit breaker and earth switches. The operation units for each switchgear are arranged zigzag in a plane.

### PREFERRED EMBODIMENTS OF THE INVENTION

In the following, one of embodiments of the present invention will be explained by reference to drawings. A typical example of the switchgear system of the present invention comprises a circuit breaker 18 of U phase in a vacuum container 10 is connected with an operation unit by means of an operating rod 24 and a driving rod 78; a circuit breaker 18 of V phase in a vacuum container 10 is connected with an operation unit by means of an operating rod 24 and a driving rod 78; and a circuit breaker 18 of W phase in a vacuum container 10 is connected with an operation unit by means of an operating rod 24 and a driving rod 78.

In a switching on operation by an operation unit 22, magneto-motive force generated from an electromagnet 76 is imparted to the driving rod 78 and the operating rod 24 to switch on the circuit breaker 18. In a switching off operation by the operation unit 22, elastic force accumulated in a trip spring 80 is impaired to the driving rod 78 and the operating rod 24 to switch off the circuit breaker 18. Operation force generated in each of the operation units 22 is transmitted to the other two phases by means of a link mechanism 26 to switch on or off the operation units of three phases simultaneously.

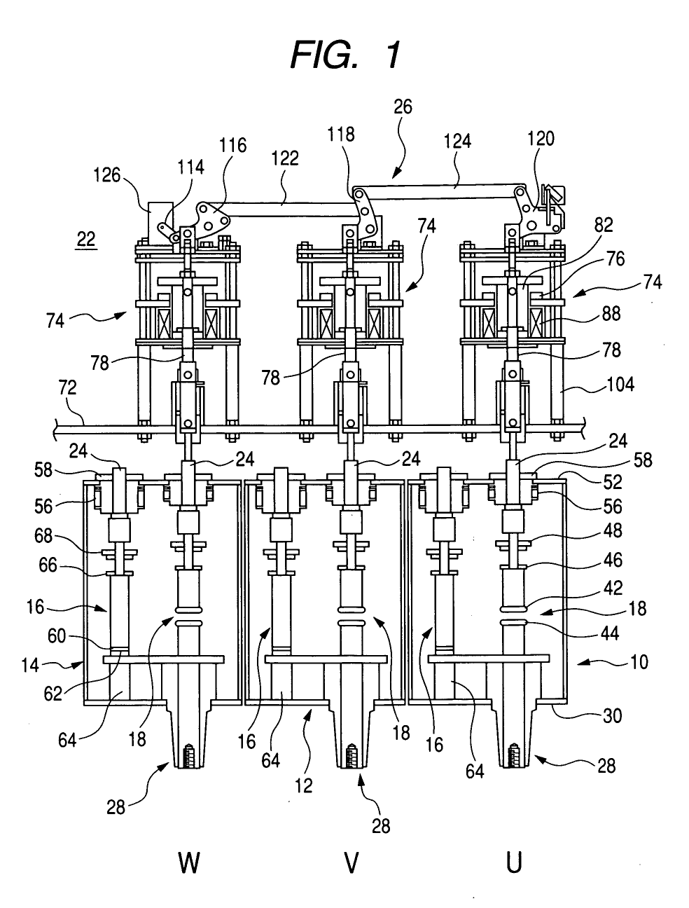

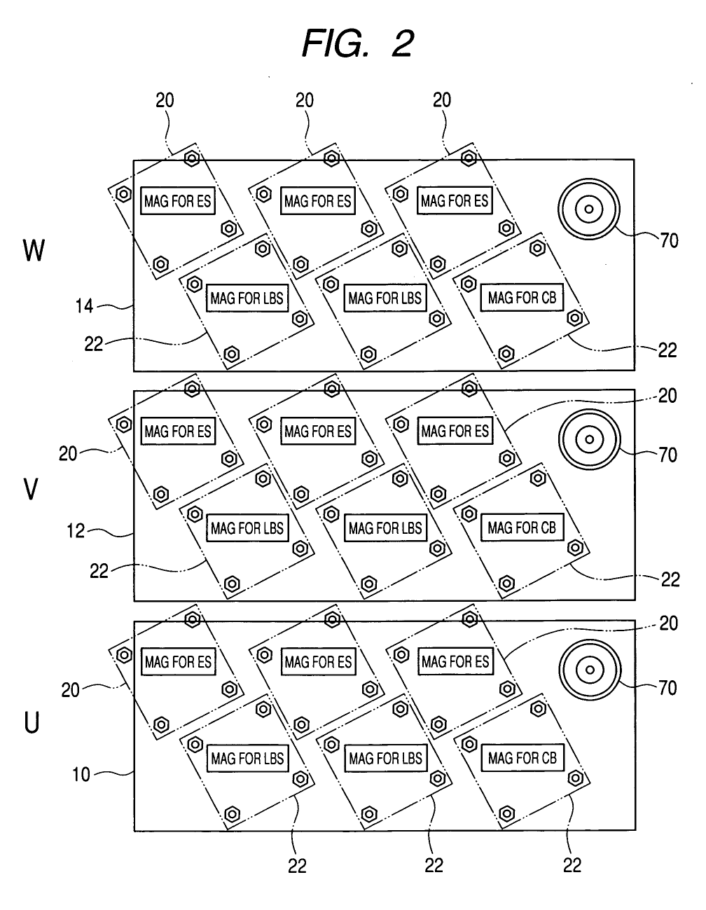

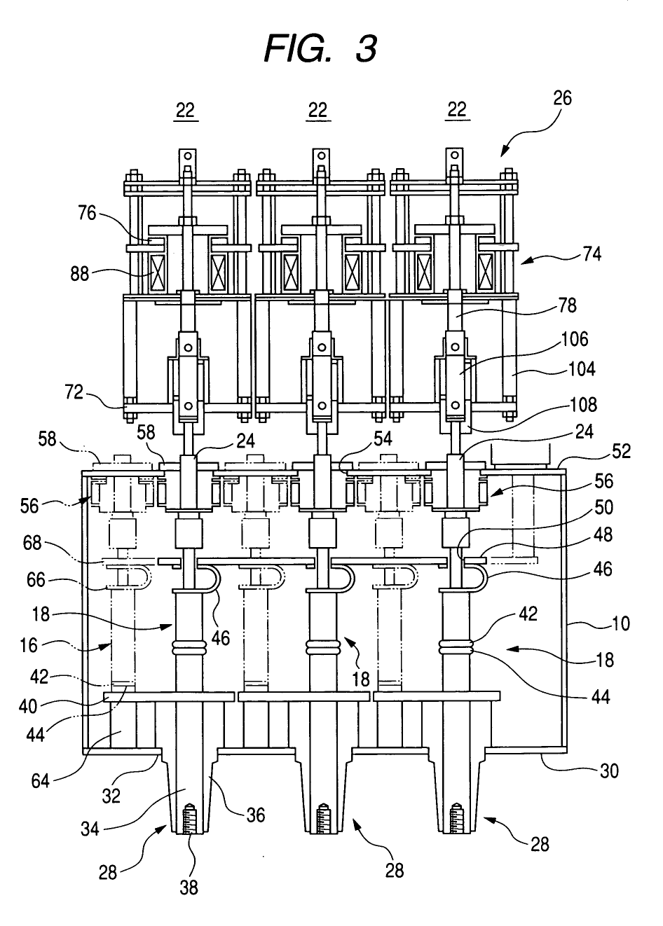

FIG. 1 is a front view of an essential part of the vacuum switchgear system of an embodiment of the present invention, and FIG. 2 is a plane view of the switchgear system shown in FIG. 1. FIG. 3 is a cross sectional view of the essential part of the switchgear system shown in FIG. 1. In FIGS. 1 to 3, a three-phase vacuum switchgear system comprises a U phase vacuum container 10, a V phase vacuum container 12 and a W phase vacuum container 14. Each of the vacuum containers 10, 12, 14 made of stainless steel accommodates as switches three earth switches 16 and three circuit breakers (or a load break switches) 18 in corresponding to a first line to third line. Three operation units 20 for operating the earth switches 16 and three operation units 22 for operating the circuit breakers 18 are disposed above the vacuum containers 10, 12, 14 of the respective phases in corresponding to the earth switches 16 and the circuit breakers 18 of the respective phases.

The operation units 20, 22 of the respective phases are arranged alternately, and they are arranged zigzag for each phase in a same plane as shown in FIG. 2. The operation units 20 are connected with earth switches 16 by means of operating rods 24, and the operation units 22 of the respective phases are connected with the circuit breakers 18 by means of operating rods 24. That is, the operation units 20, 22 of the respective phases are disposed above the vacuum containers 10, 12, 14 in opposite relation with the earth switches 10 and circuit breakers 18, and arranged coaxially with the earth switches 16 and the circuit breakers 18 along the axis of the operating rod 24.

The operation units 20, 22 of the first line to third line of the respective phases are separately constituted so as to operate independently from each other for the respective phases. On the other hand, the operation units 20, 22 of the first line, the operation units 20, 22 of the second line and the operation units 20, 22 of the third line are connected with related operation units by means of link mechanisms 26. For example, the operation units 20, 22 of the U phase in the first line are connected with the operation units 20, 22 of the other two phases (V phase and W phase) by means of the link mechanisms. That is, the operation units in different phases are independently operated and synchronously operated in the same phase in the same vacuum container.

On the other hand, the vacuum containers 10, 12, 14 of the respective phases to be earthed are provided with cable heads 28 in corresponding to the respective circuit breakers 18. Each of the cable heads 28 is fixed to the lower plate member 30 in such a state that a part thereof is projected from the bottom of the vacuum container 10, 12, 14 through the through-holes 32 formed in the lower plate member 30. Each of the cable heads 28 comprises a conductor 34 of a columnar shape made of copper and an insulating bushing 36 made of ceramics that surrounds the conductor 34. Screw portions 38 are formed at the axial ends of the conductor 34. Cables to be connected with the distribution system are screwed to the screw portions, and one end of the conductor 34 is connected with the load conductor or the bus conductor of the three phases by means of cables. The other end of the conductor 34 is connected with the circuit breaker 18 and also connected with the earth switch 16 by means of the plate conductor 40.

The circuit breakers 18 of the first line to third line are provided with movable electrodes 42 and fixed electrodes 44 as control switches for opening-closing the conducting circuits connecting between the load conductors and the bus conductors, and the movable electrodes 42 and the fixed electrodes 44 are arranged in opposite relation. The upper parts of the movable electrodes 42 connected with the operating rods 24, and also connected with the conductor 48 by means of a flexible conductor 48. The plate conductors 48 are arranged over the circuit breakers 18 for the first line to the third line.

Each of the conductors 48 has a through-hole 50 at a position corresponding to an axis of the circuit breaker 18. Each of the operating rods 24 is inserted into the through-hole 50 in reciprocal relation (up and down movement). The operating rod 24 is inserted into the through-hole 54 formed in the upper plate member 52 in reciprocal relation (up and down movement). The upper part of the operating rod 24 is covered with a cylindrical bellows 56 and a disc base 58; the bellows 58 is fixed to the surface of the upper plate 52.

Each of the earth switches 16 for earthing each of the circuit breakers comprises a movable electrode 60 and a fixed electrode 62; the electrodes are arranged to oppose to each other. The fixed electrode 62 is connected with a conductor 40; a ceramic supporting member 64, which is fixed to the lower plate member 30 supports the fixed electrode side of the conductor 40.

The movable electrode 60 is connected with the operating rod 24 of the operation unit 20 for the earth switch and connected with the conductor 48 by means of a flexible conductor 68. The conductor 68 which is shaped into a plate as same as the plate conductor 48 is arranged over the switches 16 of the first line to the third line. The end of the plate conductor is connected with a connecting terminal 70. That is, the earth switches 16 ground the circuit breakers 18 with the conductor 40, the earth switches 16, the flexible conductor 66, the conductor 68 and the earthing terminal 70 upon contacting the movable electrode 60 with the fixed electrode 62. The conductor 68 is provided with a through-hole (not shown) for reciprocating the operating rod 24 (up and down movement). The bellows 56 and the base surround the operating rod 24.

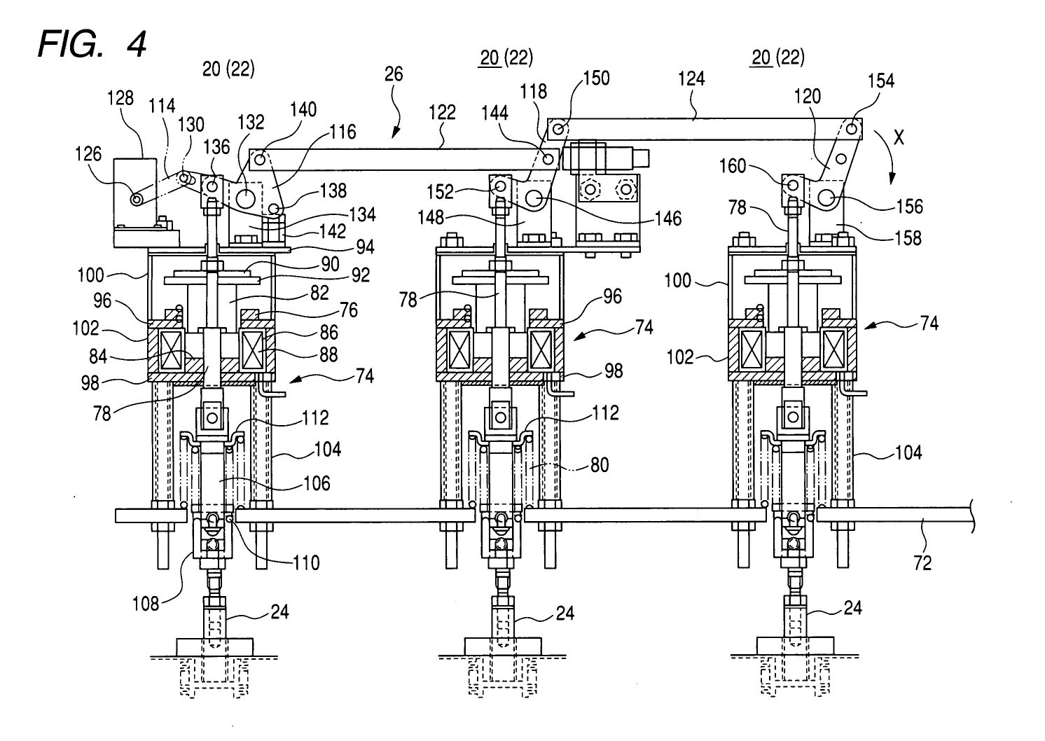

On the other hand, each of the operation units 20, 22 of each of the phases is fixed to the fixing plates 72 as shown in FIG. 4. A switchboard (not shown) supports the fixing plates 72. Each of the operation units 20, 22 of each phase is arranged in a line for each of the first line to the third line. In order to impart operation force of magneto-motive force to the operating rods 24 upon closing of each of the earth switches 16 and each of the circuit breakers 18, each of the operation units 20, 22 comprises an electro-magnet 74, a permanent magnet 76, a driving rod 78, etc. Each of the operation units 20, 22 is provided with a trip spring 80 so that operation force of the elastic force in the reverse direction of that of the magneto-motive force is imparted to each of the operating rods 24 upon opening of each of the earth switches 16 and each of the circuit breakers 18. Further, each of the driving rods 78 is connected with the link mechanism 26 for each of the first line, the second line and the third line, thereby to perform three phase operation.

The electro-magnet 74 is provided with a driving rod 78 as one element, and also provided with a movable iron core (plunger) 82, a fixed iron core 84, a coil bobbin 86, a coil 88, movable disc plates 90, 92, iron supporters 94, 96, 98 of disc form, iron covers 100, 102 of a cylindrical form, a fixed rod 104, etc. The lower part of the fixed rod 104 is fixed to the fixing base plate 72 by means of a bolt and a nut. The driving rod 78 having a columnar shape is arranged on a coaxial line of the operating rod 24 so that the driving rod 78 is capable of reciprocating up and down in the through-hole or a hollow formed in the center of the iron supporters 94, 96, 98. The movable iron core 82 and the movable plates 90, 92 are fixed around the driving rod 78, and a fixed iron core 84 is disposed opposite to the diving rod 78.

The fixed iron core 78 of an annular shape is fixed to the surface of the iron supporter 98. The coil bobbin 86 of an annular shape is disposed to surround the driving rod 78 and the fixed iron core 84. The coil bobbin 86 of an annular shape is arranged to surround the driving rod 78 and the fixed iron core 84. The supporters 96, 98 support the top end and the bottom end of the coil bobbin. An annular coil 88 is disposed in the coil bobbin 86. An annular permanent magnet 76 is disposed adjoining the coil 88 and is supported by the supporting plate 96.

The coil 88 is provided with current in response to a closing signal or an opening signal. When electric current is supplied to the coil 88, a magnetic field is generated around the coil 88 a path consisting of movable iron core 82—fixed iron core 84—supporting plate 98—cover 102—supporting plate 96—movable iron core 82. The magnetic field causes the bottom portion of the movable iron core 82 in the axial direction thereof generate an attractive force in the downward direction so that the movable iron core 82 and the driving rod 78 move toward the fixed iron core 84. Thus, the movable iron core 82 is adsorbed to the fixed iron core 84 to make contact between the movable iron core 82 and the fixed iron core 84. In this case, since the direction of the magnetic field generated by the permanent magnet 76 is same as that of the magnetic field generated by the coil 88, the movable iron core 82 moves toward the fixed iron core 84 in such state that the magneto-motive force generated by the electro-magnets 74 is enhanced, i.e. the adsorption force is enhanced. The magneto-motive force generated by the electro-magnets 74 and the permanent magnets 76 is imparted to the driving rod 78 as an operating force for pressing down the driving rod 78 (toward the operating rod 24).

The lower part of the driving rod 78 is connected with the upper part of the operating rod 24 by means of the connecting rods 106, 108. Therefore, the operating rod 24 moves downward as the driving rod moves downward so that the earth switch 16 or the circuit breaker 18 is switched on. The connecting rod 106 is inserted together with the connecting rod 108 into the through-hole 110 formed in the fixing plate 72, thereby to reciprocate (up and down movement). The supporting plate 112 is fixed to the upper side of the connecting rod 106. A trip spring 80 is disposed between the supporting plate 112 and the fixing plate 72. An elastic force (spring force) is accumulated in the trip spring 80 when the driving rod 78 moves down.

On the other hand, the trip spring 80 imparts accumulated elastic force (spring force) to the driving rod 18 and the operating rod 24 when the coil 88 becomes non-conduction in response to opening signal or opening operation. The operating force of the elastic force is set to be larger than the magneto-motive force of the permanent magnet 76; when the elastic force accumulated in the trip spring is imparted to the driving rod 78 and the operating rod 24 as the operating force, the driving rod 78 and the operating rod 24 moves upward against the magneto-motive force of the permanent magnet 76 to open the earth switch 16 or circuit breaker 18.

The link mechanism 26 converts operating force along the vertical direction with respect to the operating rod 24 to an operating force in the direction intersecting the driving rod 78 and the operating rod 24, that is, the direction along the horizontal direction so that the operation units of the respective three phases are operated.

More concretely, the link mechanism 26 comprises links 114, 116, 118, 120 and connecting rods 122, 124; one end of the link 114 is connected swingingly with the base 128 by means of a pin 126. The base 128 is fixed to the supporting plate 94 by means of a bolt and a nut. The other end of the link 114 is connected swingingly with one end of the link 116.

The link 116 is connected swingingly as a link for W phase with the base 134 by means of the pin 132, and the base 134 is fixed to the supporting plate 94 by means of a bolt and a nut. The link 116 is disposed swingingly with respect to the pin 132 as a fulcrum. Pins 136, 138 are fixed to the link 116 on the line connecting the center of the pin 130 and pin 132, wherein the pin 132 is located between the pins 136 and 138. A pin 140 is fixed at a position that intersects the line connecting the center of the pin 130 and the center of the pin 138. The driving rod 78 is connected with the pin 136 to swing, and one end of the connecting rod 122 is connected with the pin 140 to swing. A stopper 142 is disposed below the pin 138, which is fixed to the supporting plate 94. The pin 138 prevents the link 116 from downward swinging by contacting with the stopper 142, when the operation units 20, 22 of the W phase are operated to open.

The connecting rod 122 is disposed reciprocally along the horizontal direction that intersects the driving rod 78, and the one end of the axis of the connecting rod 122 is connected swingingly with the link 118 by means of the pin 144. The link 118 as a link for V phase is swingingly connected with the base 148 by means of the pin 146. The base 148 is fixed to the supporting plate 94 by means of a bolt and a nut. The link 118 is disposed swingingly with respect to the pin 146 as a fulcrum. The pin 150 is fixed on the line connecting the center of the pin 146 and the center of the pin 144. The pin 152 is fixed in the direction interesting the line connecting the center of the pin 146 and the center of the pin 150.

The pin 152 is connected swingingly with the driving rod 78, and the pin 150 is connected swingingly with the connecting rod 124. The connecting rod 124 is disposed swingingly in the direction that intersects the driving rod 78 and the operating rod 24, i.e. the horizontal direction. One end of the oprtating rod 24 in the axial direction is swingingly connected with the pin 154 of the link 120. The link 120 as a link for U phase is provided with the pin 156; the pin 156 is connected swingingly with the base 158. The base 156 is fixed to the supporting plate 94 by means of a bolt and a nut. The link 120 is disposed swingingly with respect to the pin 156 as a fulcrum. The pin 160 is fixed in the direction perpendicular to the line connecting the center of the pin 154 and the pin 156. The pin 160 is connecting swingingly with the end portion of the driving rod 78.

In the above construction, when an operation signal is given the operation unit 20 or 22 of the first line and when the coil 88 of the electromagnet is turned on, the movable iron core 82 moves toward the fixed iron core 84 and the driving rod 78 and the operating rod 74 move downward. The operating force is transmitted to the links 116, 118, 120, and each of the links 116, 118, 120 is swung in the direction of the arrow X around the pins 132, 146, 156 as a fulcrum as shown in FIG. 4. As a result, the operating force of each of the phases is transmitted to the operation units of the other two phases to simultaneously switch on each of the earth switches 16 or each of the circuit breakers. That is, each of the earth switches 16 and each of the circuit breakers 18 are switched on simultaneously without displacement.

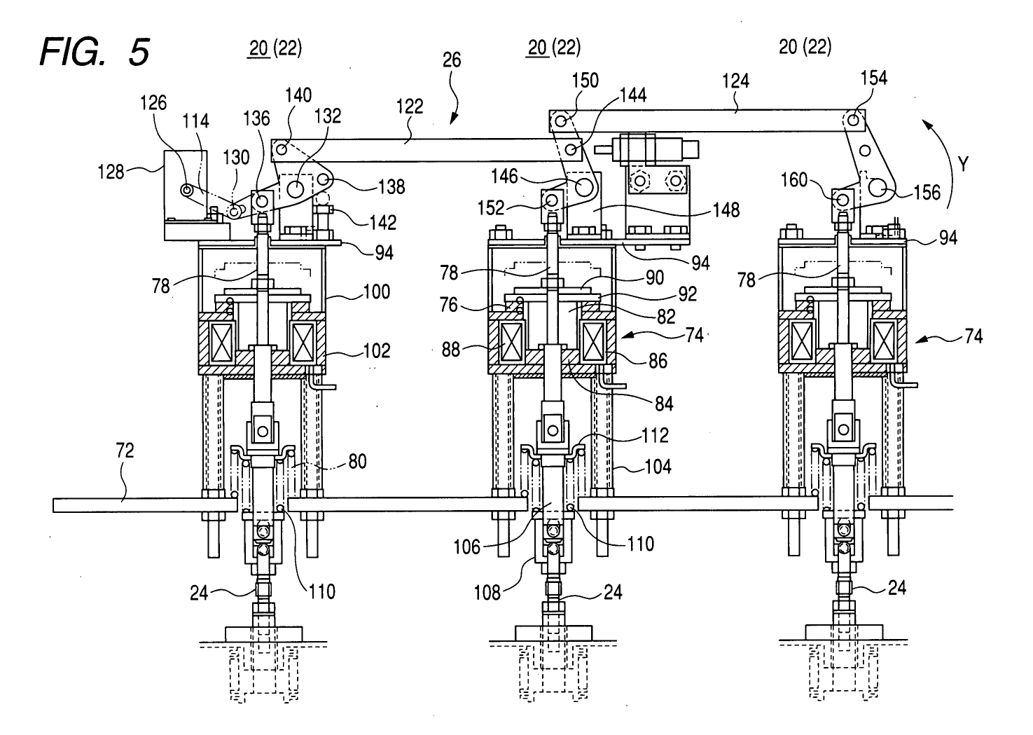

On the other hand, when an opening instruction is issued to the operation unit 20 or 22 of the first line to switch off each of the coils 88 (non-excited state), the movable iron core 82 separates from the fixed iron core 84 to move the driving rod 78 24 upward. At the same time, each of the links 116, 118, 120 of the respective phases swing in the direction of the arrow Y as shown in FIG. 5 around the pins 132, 146, 156 as a fulcrum to transmit the operating force generated from each of the operation units to the other two operation units. As a result, each of the earth switches 16 or each of the circuit breakers 18 of the respective phases is switched off simultaneously with other switches.

According to this embodiment, if the operation units 20, 22 of each of the phases are switched on, the magneto-motive force generated from the electro-magnets 74 and the permanent magnets 76 is given the driving rod 78 and the operating rod 24, and if the operation units 20, 22 of each of the phases are switched off, the elastic force accumulated in the trip spring is given the driving rod 78 and the operating rod 24. Accordingly, the operation units 20, 22 can be made smaller than the operation units using only elastic force of springs.

Since the three phase switching on or off operation by transmitting the operating force generated from the operation units 20, 22 to the other two operation units, there is no displacement among the phases and the earth switches 16 or the circuit breakers 18 are switched on or off simultaneously or in synchronism.

Further, since the operation units of the respective phases are constituted by the same elements, the elements can be shared and assembly work is simplified.

Since the operation units 20, 22, the earth switches 16 and the circuit breakers 18 are arranged on the same axis, the distance between the operation units 20, 22 and the vacuum containers 10, 12, 14 can be made small so that the switchgears and the installation area can be made small.

Since the operation units 20, 22 of the respective phases are arranged zigzag, the distance between the operation units 20, 22 can be made small so that the installation area can be made further small.

Since the operation units 20, 22 of the respective phases are disposed above the vacuum containers 10, 12, 14 and since the part of the cable heads 28 is projected from the lower part of the vacuum containers 10, 12, 14, the height of the switchgear becomes smaller.

In the above-described embodiment, the earth switches 16 and the circuit breakers 18 of the respective phases are accommodated in separate vacuum containers; the earth switches 16 and the circuit breakers 18 of the respective phases can be accommodated in a single vacuum container.

Although the above description has been made on the switchgear comprising operation units 20, 22 which have the electro-magnets 74 and the permanent magnets 76, the permanent magnets 76 can be omitted if the electro magnets generate the magneto-motive force of a sufficient strength.

In the above described embodiment, although the coils of the electromagnets 20, 22 are made switched off (non-conductive) when the operation units 20, 22 are switched off, current is supplied to the coils 88 of the operation units 20, 22 in the direction opposite to that of switching on, the magneto-motive force whose direction is opposite to that of switching on is generated from the electromagnet 74 and the magneto-motive force is given the driving rod 78. As a result, the operating force in switching off can be further enhanced. In this case, the trip spring having a smaller elastic force (spring force) than the spring in the former embodiment can be employed.

In the embodiment, if the circuit breakers 18 are covered with arc shields, the arc shields shield metal vapor generated at the time of contacting and separating of the electrodes.

1. A vacuum switchgear system for a three phase electric power transmission system, which comprises three switchgears each comprising a vacuum switch and an operation unit, wherein each of the vacuum switches comprises a vacuum container and at least a main switch and earth switch and each of the operation units is coaxially connected with an operating rod of each of the switches, wherein the operation units of each of the switchgears are connected with the adjoining operation units of the switchgear in the same phase by means of a link mechanism connected with respect to driving rods of the operation units, and wherein the link mechanism transmits a force of the driving rod to the adjoining driving rods so that the switches in the same phase are operated in synchronism in response to a switch-on signal or a switch-off signal.

2. The vacuum switchgear system according to claim 1, wherein each of the link mechanism comprises a swing member one end of which is connected with one end of the driving rod of each of the operation units to convert a reciprocal movement of the driving rod into a swing movement and a connecting rod one end of which is connected with the swing member and the other end is connected with the adjoining swing member to convert the swing movement into a lateral movement.

3. The vacuum switchgear system according to claim 1, wherein the driving rod is assisted by an electromagnet in closing the switches and is assisted by the electromagnet and a permanent magnet in opening the switches.

4. The vacuum switchgear system according to claim 1, wherein the link mechanisms are restrained in the system so as to synchronize the lateral movement of the connecting rods of the three switchgears.

5. A vacuum switchgear system, which comprises three switchgears for three phases each comprising a vacuum switch and an operation unit, wherein each of the switches comprises an earth switch and a circuit breaker accommodated in a vacuum container, each of the operation units being coaxially connected with an operating rod of each of the switches, wherein the operation units of the three switchgears are connected with the adjoining operation units of the switchgears by means of link mechanisms, each of the link mechanisms having a first member which is connected with one end of a driving rod of each of the operation units and is disposed to swing around its connecting point as a fulcrum and a second member which is connected with one end of the first member to convert a swing movement of the first member into a lateral movement and transmit the lateral force to the adjoining link mechanisms, whereby the three switchgears are operated synchronously in response to a switch on signal or a switch off signal.

6. The vacuum switchgear system according to claim 1, wherein each of the operation units being connected with each of the switches by means of an operating rod, wherein each of the operation units imparts the operating force by magneto-motive force to the operating rod in closing the switches.

7. The vacuum switchgear system according to claim 1, wherein in opening of the switches an operating force by elasticity in the reverse direction with respect to the electro-motive force to the operating rod, each of the operation units of each of the phases being connected with two switches having relation with the operation unit.

8. The vacuum switchgear system according to claim 1, wherein each of the switches and each of the operation units having relation with the switch are arranged in the closest relation on a same axis with respect to the operating rod.

9. The vacuum switchgear system according to claim 1, wherein each of the operation units is disposed above each of the switches having relation with the operation unit on an axis of the operating rod.

10. The vacuum switchgear system according to claim 1, wherein each of the switches comprises three load break switches, a circuit breaker and earth switches.

11. The vacuum switchgear system according to claim 10, wherein the operation units for each switchgear are arranged zigzag in a plane.

12. The vacuum switchgear according to claim 1, wherein each of the plurality of operation units comprises a driving rod connected with the operating rod, one end of which is disposed in a coaxial relation with the operating rod in a manner as to reciprocate; a movable iron core fixed to the driving rod; a fixed iron core disposed at a position which is closer to the operating rod than the movable iron core; electro-magnets arranged around the movable iron core and the fixed iron core to generate electro-motive force in response to a closing signal or an opening signal, whereby the electromotive force is imparted to the driving rods as a force for contacting the movable iron core and the fixed iron core and generation of the electro-motive force in response to the opening signal or opening operation is stopped; and trip springs each connected with the driving rod for accumulating elastic force by movement of the driving rod due to generation of the electro-motive force, whereby the accumulated force is imparted to the movable iron core and the fixed iron core as an operating force to separate them when the generation of the electromotive force is stopped.

13. The vacuum switchgear according to claim 1, wherein each of the plurality of operation units comprises a driving rod connected in a coaxial relation with each of the operating rod and in reciprocating relation with each of the operating rod at one end thereof, a movable iron core fixed to the driving rod, a fixed iron core disposed opposite to the movable iron core at a position closer to the operating rod than to the movable rod, electro-magnets arranged around the movable iron core and the fixed iron core for generating electro-motive force in response to a closing signal or an closing operation so that a first electro-motive force is imparted to the driving rod thereby to contact the movable iron core and the fixed iron core and in response to an opening signal or an opening operation a second electro-motive force is generated in the direction opposite to the first electro-motive force, and trip springs each of which is connected with the driving rod and accumulates elastic force by movement of the movable iron core and the fixed iron core so as to contact them, and when an electro-motive force in the second electro-motive force is generated, the separation force is imparted to the operating rod.

14. The vacuum switchgear according to claim 1, wherein each of the plurality of operation units comprises a driving rod one end of which is connected with each of the operating rods in coaxial relation for reciprocating, a movable iron core, a fixed iron core disposed at a position closer to the operating rod than to the movable iron core, electro-magnets arranged around the movable iron core and the fixed iron core, whereby magneto-motive force is generated in response to a closing signal or a closing operation, and whereby the magneto-motive force is imparted to the driving rod in response to contact the movable iron core and the fixed iron core or to stop the generation of magneto-motive force in response to an opening signal or an operation signal, permanent magnets arranged adjoining the electro-magnets for generating magneto-motive force in the same direction of that of the magnet-motive force generated by the electro-magnets, the magneto-motive force generated by the permanent magnets being imparted to the driving rods as an operating force for contacting the movable iron core and the fixed iron core, and trip springs connected with the driving rod for accumulating elastic force by movement of the driving rod upon generation of the magneto-motive force , when the generation of magneto-motive force stops, the accumulated elastic force is imparted to the operating rod as an operating force for separating the movable iron core and the fixed iron core.

15. The vacuum switchgear according to claim 1, wherein each of the plurality of operation units comprises a driving rod one end of which is connected with each of the operating rods in coaxial relation for reciprocating, a movable iron core, a fixed iron core disposed at a position closer to the operating rod than to the movable iron core, electro-magnets arranged around the movable iron core and the fixed iron core, whereby magneto-motive force is generated in response to a closing signal or a closing operation, and whereby the magneto-motive force is imparted to the driving rod in response to contact the movable iron core and the fixed iron core or to stop the generation of magneto-motive force in a direction opposite to that of the above magneto-motive force in response to an opening signal or an operation signal, permanent magnets arranged adjoining the electro-magnets for generating magneto-motive force in the same direction as that of the electro-magnets in the same direction of that of the magnet-motive force generated by the electro-magnets, the magneto-motive force generated by the permanent magnets being imparted to the driving rods as an operating force for contacting the movable iron core and the fixed iron core, and trip springs connected with the driving rod for accumulating elastic force by movement of the driving rod for contacting the movable iron core and the fixed iron core, when the magneto-motive force generates in the opposite direction, the accumulated elastic force is imparted to the operating rod as an operating force for separating the movable iron core and the fixed iron core.
